(19) United States
(12) Patent Application Publication
(10) Pub. No.: US 2002/0088127 A1
(43) Pub. Date: Jul. 11, 2002

(54) Can opener

(76) Inventor: Leslie Peter Stuart Wilson, Northamptonshire (GB)

Correspondence Address: WESTMAN, CHAMPLIN & KELLY, A PROFESSIONAL ASSOCIATION, INTERNATIONAL CENTRESUITE - 1600, 900 SECOND AVENUE SOUTH, MINNEAPOLIS, MN, 55402-3319, US

(21) Appl. No.: 09/954,485

(22) Filed: Sep. 17, 2001

(30) Foreign Application Priority Data
Sep. 21, 2000 (GB) 0023039.1

(51) Int. Cl. B67B 7/46; B67B 7/72

(52) U.S. Cl. 30/420; 30/400

(57) ABSTRACT

A can opener, comprising first and second handle members, knife means, drive wheel, ratch device and the spring, wherein the said first handle members and the second handle members are pivotally connected about an axis, and a radially facing slot is formed on the first handle members, and also a apporiate protrusion in shape is also formed on the said first handle members; The cutting wheel being rigidly mounted onto the first handle member, The drive wheel partly protruding through said slot, and engages with the said first handle members and and the second handle members through the axis; the ratch device and the spring are disposed above the second handle members as well as under the drive wheel, in which one end of the spring is mounted on the first handle members, and the other end is mounted on the second handle members.

The present invention relates to a can opener, more particularly, but not exclusively, to a manually operable can opener of the kind having two handles pivoted together.

Several well known can openers comprise a pair of handles pivoted together, wherein one handle carries a slideably mounted or a fixed cutting wheel or a knife and the other handle carries a toothed or driving wheel, which is mounted on to a shaft which in turn is rotated by a butterfly plate or handle.

It has long been recognized that there is a need for a simple can opener, operable with one hand, and of simple construction. Application Number GB 2161449A discloses a can opener wherein the cutting element is slideably mounted so that a pair of handles may be squeezed together to cause the cutter to penetrate the can, and a further handle causes the shaft holding the drive wheel to rotate.

In this and other cited references the cutter clement is mounted in such a way that it can be moved on its mounting either slideably or by rotation on an eccentric or other means, in order to nip or penetrate the can top or wall. Other cited references also disclose a drive wheel which is mounted onto a drive shaft and then rotated by a ratchet or clutch device.

All of the above disclosures have disadvantages of cost, gearing or complexity of manufacture and use.

According to one aspect of the present invention, there is provided a can opener comprising first and second handle members pivotally connected about an axis to be moveable between an open disposition and a closed disposition, a cutting wheel or knife means being rigidly mounted onto the first handle member, a radially facing slot formed through a part of said first handle member. and a drive wheel partly protruding through said slot to engage the rim of the can and press it against the cutting wheel or knife means.

The drive wheel may be mounted rotatably onto a support shaft or rivet which is held slideably in a slot in the main plate of the first handle.

The support shaft is preferably not fixed to the drive wheel and does not supply any rotative drive to the wheel.

Preferably, said shaft does not even rotate, but slides in said slot and has a suitable larger diameter head on the same side as the cutting device of said handle plate.

The first handle member is shaped as a doubly bent plate and said slot is provided in the portion thereof connecting the two bonds.

The large drive wheel is thus free to rotate while lying flat on the side of the first handle plate, beyond the double bend and rotatable around the shaft, which is free to slide in the slot provided in that plate.

The second handle member may have a suitable hole and bearing material in the upper portion of the handle near to the drive wheel and which fits over the same shaft or rivet on which it freely rotates.

This second handle member may also be fitted with a ratchet device or clutch so that. when the two handles are squeezed together, the ratchet causes the drive wheel to rotate in that direction only.

A return spring may be fitted, conveniently underneath the second handle member and above the drive wheel, to cause the second handle to move apart from the first handle after the squeeze movement.

An appropriate end of this spring, where it is mounted on to the second handle, may also be used to operate said ratchet and thus avoid the use of a separate spring part for this purpose.

This spring may conveniently be of a coil spring form and may be so mounted that one end is fixed to the first handle member, and the other to the second handle member,

The spring can thus also cause the second handle member, when released from the nip or cutting position, to return to the non-nip or release position by causing the shaft to slide down its slot and, in so doing, to withdraw the drive wheel teeth from the side of the first handle member near to the cutting wheel or knife means, thereby releasing the can without further and possibly unnecessary opening of the handles.

The first handle plate may also have a sloped or conveniently shaped approach to the said slot in the double bend on the same side of said handle as the cutter, to facilitate the insertion of the unopened can into the space below the cutter and which slope can ensure the correct angle of the can to the cutter. The drive wheel teeth are at this stage below the surface of this plate to facilitate correct insertion of the can.

When the second handle is first squeezed towards the first handle after the can is in place, it presses against a cam or suitable shaped portion of the first handle plate, which provides strong leverage to lift the shaft or rivet, holding the drive wheel along its slot, so that the drive wheel teeth rise through the slot in the double plate bend and engage the rim of the can on its underside, forcing it against the fixed cutter device to penetrate the top of the can.

It will be observed that the drive wheel is already rotating due to the ratchet drive on the second handle and this rotation causes the drive wheel to move further along its slot in a direction roughly parallel to that of the axis of the first handle, due to the engagement of the hardened teeth of said wheel with the softer material of the rim of the can.

This movement causes the second handle member, the drive wheel, the spring and the ratchet system all to move in the above direction by a few millimeters, thus the tip of said second handle member becomes disengaged from the cam on the first handle and enables the full squeeze movement of the second handle member to be completed.

On releasing the spring loaded second handle at the completion of the squeeze action, it will open outwardly until the upper portion of the second handle member above its fulcrum at the shaft or rivet encounters a further cam or similar fixed object on the side of the first handle member remote from the cutter, which limits the normal opening of the handles one from the other for the next squeeze.

However, if the second handle member is pushed against the above described spring beyond this point, the drive wheel and the second handle and spring will move along the said slot in the opposite direction to that which caused the nip and cutting, and the spring will move the drive wheel away from the rim of the can and back towards the other cam, and thereby form the leverage for the nip penetration of the can.

The can may be firmly held while the two handle members are held together to facilitate the pouring of hot soup or the like from the can, which can then be discarded by opening the handles as described above.

A magnet may also be fitted at or near to the cutter to retrieve the severed lid of the can.

The use of a large drive wheel eliminates the need for gearing and the like which was tried in Application Number EP 0503931 B1 in order to reduce the number of squeezes required to open a can. A large wheel can not reasonably bc used as in this example, to open a small or irregularly shaped can, or where it is desired to cut off the top of the can by cutting the cylindrical can wall. For this reason, the present invention is conveniently, but not exclusively, arranged to cut the lid or inner top surface of the can, thus leaving a safe upper edge and avoiding spillage, while the large wheel rotates around the outside lower edge of the can rim and causes a small cutter to go around the upper inside edge of the can and remove the top surface, leaving a smooth edge of the can.

It will be clear this invention is simple and has a minimal number of parts and is assemblable with only one rivet or shaft.

An embodiment of the present invention will now be more particularly described by way of example and with reference to the accompanying drawings, in which:

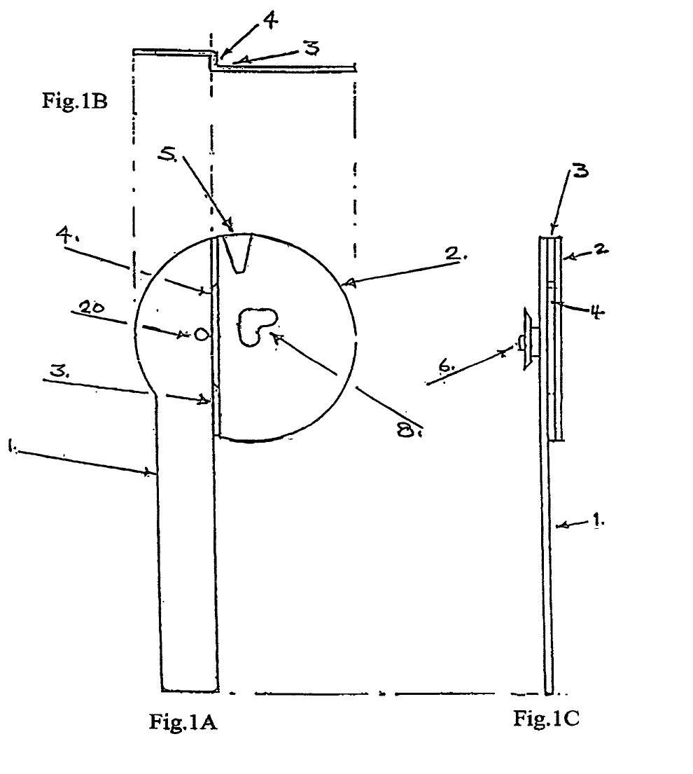

FIG. 1A is an elevation of a first handle from the side remote from a cutter,

FIG. 1B is an end elevation of the handle of FIG. 1A.

FIG. 1C is a side elevation of the handle of FIG. 1A,

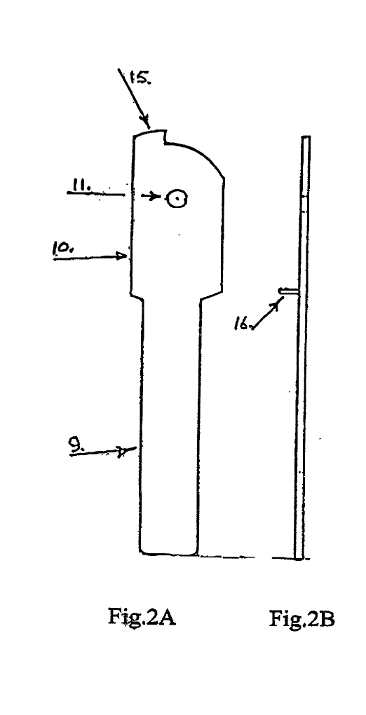

FIG. 2A is an elevation of a second handle (from the side adapted to be remote from the cutter);

FIG. 2B is a side elevation of the second handle of FIG. 2A;

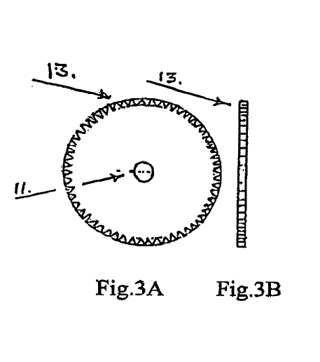

FIG. 3A is an elevation of a drive wheel;

FIG. 3B is a side elevation of the drive wheel of FIG. 3A;

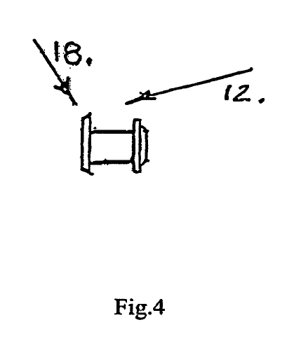

FIG. 4 is a side elevation of a rivet for assembling the device;

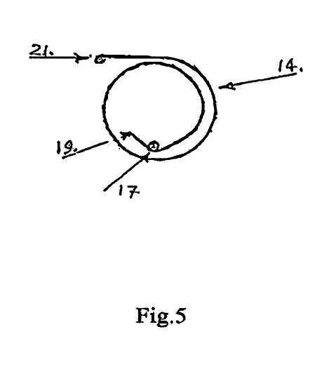

FIG. 5 is illustrates a spring used in the device;

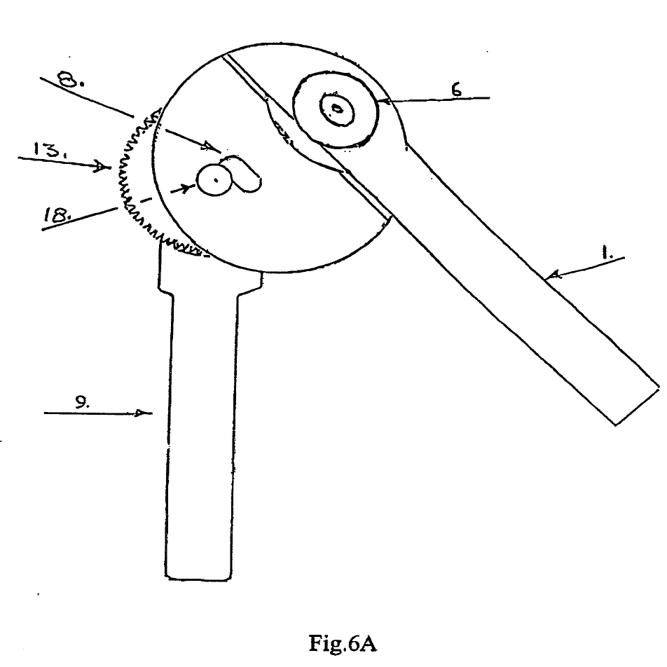

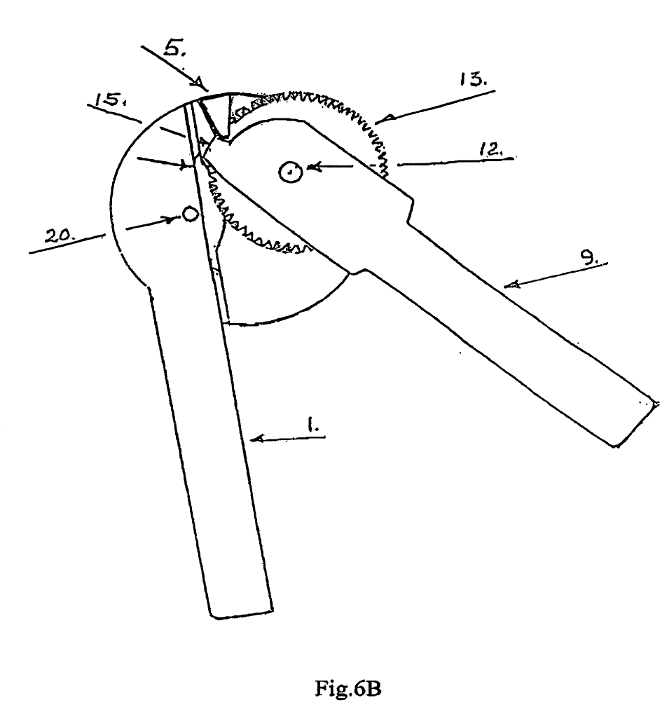

FIG. 6A is an elevation of an assembled device;

FIG. 6B is an elevation from the opposite side of the device of FIG. 6A;

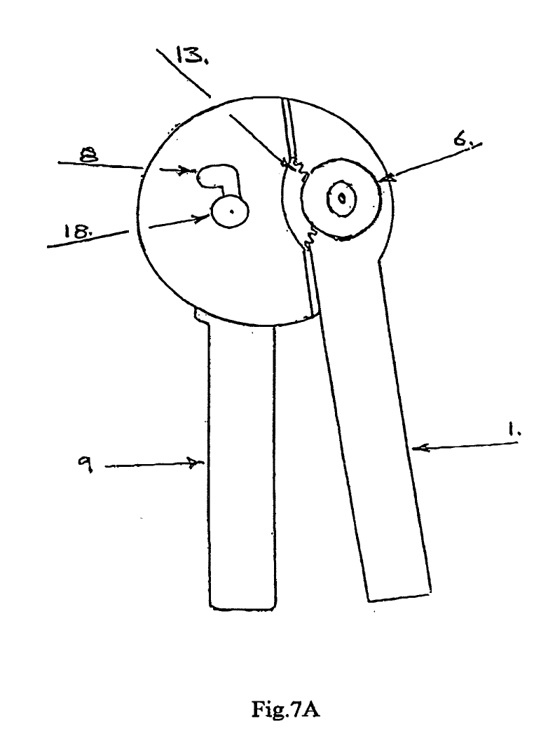

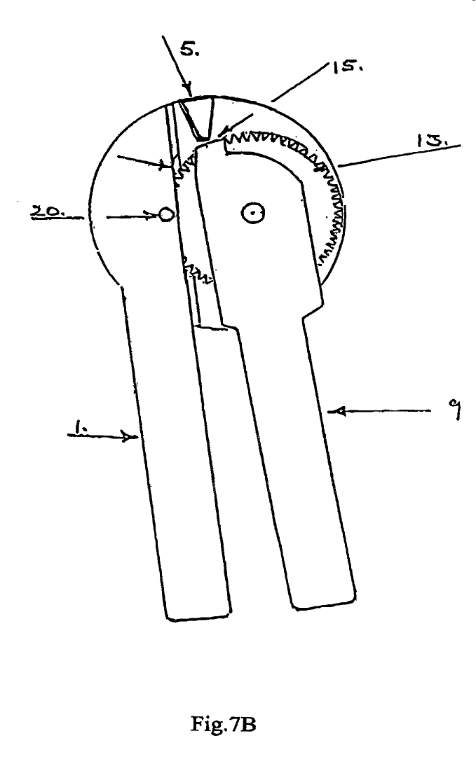

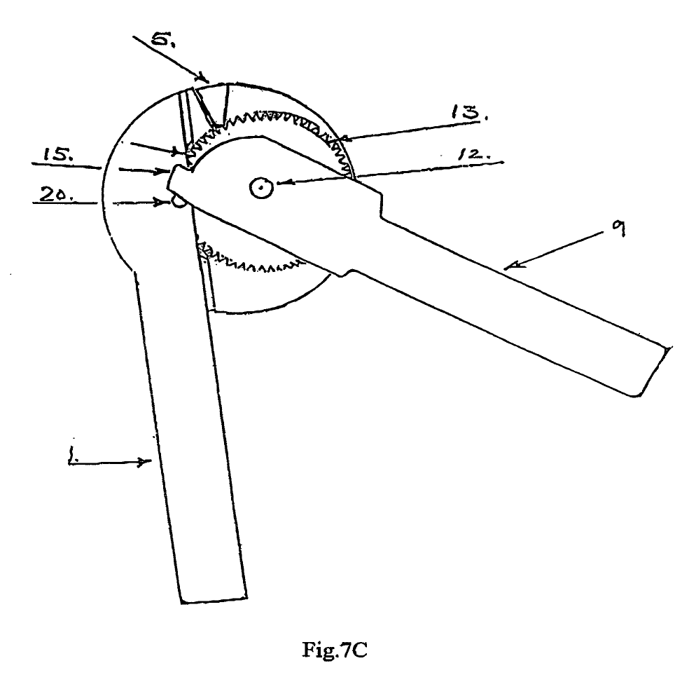

FIG. 7A is an elevation corresponding to that of FIG. 6A, but with the device in gripped condition,

FIG. 7B is a reverse elevation of the device shown in FIG. 2A, and.

FIG. 7C is an elevation of the device of FIGS. 6 and 7 in most open condition.

Referring now to the drawings FIG. 1A shows a first embodiment of part of the invention. A first handle or plate 1,2 is shown from a side remote from a cutter wheel or knife. Handle 1 forms an integral part of the plate 2, which is formed into a double bend 3, which has a cut-away slot 4 through part of the centre part of this double bend in the body of the plate 2.

A cam type device 5 is provided which may form an integral pan of the plate 2 and which must be so bent into place as to engage the second handle 9 as required, but which must also clear a drive wheel 6.

FIG. 1B is an end view of the first handle 1 and plate 2 as seen from the direction from the handle 1 towards the plate end 2 and shows in side elevation the nature of the double bend 3 and the slot 4 in that bend.

FIG. 1C is a side view of the handle 1, the plate 2, the double bend 3 in that plate and the slot 4 cut into that bend, seen from the side as an elevation from the side remote from the handle 1 and also showing a cutter wheel 6 or similar cutting knife or device, which is permanently fixed in position, but not taking into account the exact rake or angle of fixture for the sake of clarity of drawing and explanation. A slot 8 is shown in approximately its position and shape.

FIG. 2A is an elevation of the second handle 9 as seen from the side remote from the cutter 6 when this second handle is mounted onto the can opener. A second plate 10, which forms an integral part of the second handle 9 has a hole 11, possibly fitted with a bearing surface, to permit the passage of the shaft or rivet 12, which can hold the drive wheel 13, the handle and plate 9, 10 as well as a spring 14 onto the plate 2 and first handle 1, via the slot 8. The upper end of the second handle plate 10 has a curved and raised portion 15, which is designed to engage the cam device 5, in order to produce the leverage required to effect the pinch, nip or penetration of the can top or lid.

FIG. 2B is a side view of the same second handle 9, having as a part of it the raised portion 15 and showing also a small stud or other fixing suitable to hold the spring 14 at its lower point onto the handle at the point 16 (or near to that point). A loop in a spring 17 may be the fixing point for the return spring 14 onto the second handle plate 11 and the protruding tail or end of this fixing loop may also be used as the spring for the ratchet device which may engage the teeth of the drive wheel 13.

FIG. 3A is a view of the drive wheel 13 with peripheral teeth and a suitable hole 11, which may also have a suitable bearing material fitted to it, the teeth are cut completely around the circumference of this wheel and the wheel is hardened.

FIG. 3B is a side view of drive wheel 13, which shows that the wheel may be the same on both sides, but which may be adapted to improve the ratchet or driving effects.

FIG. 4 is a side view of a shaft or rivet 12 which can be used to assemble the can opener. It may have a partly flattened head 18 which slides against the side wall of the can to permit the correct angle of cutting of the can top and to retain the rivet shaft 12 within the slot 8 and support, but not rotate, the drive wheel 13 and to hold in place the second handle plate 11. It may be fixed by a loop 17 onto the stud at 16 on the second handle 11. The tail or outer extremity of loop 17 may be used as the spring for the ratchet device 19.

FIG. 5 shows the spring 14, which may perform three functions. Firstly, it is the return spring for the manually squeezable can opener. Secondly, it may be used as the ratchet return spring. Thirdly, it may be used to ensure that the handle and plate 9, 11 return to the fully released position to release the can. This may occur after the can has been opened by fully withdrawing the drive wheel from the slot 4, and placing the raised portion 15 of the second handle plate 11 adjacent to the cam 5, after the nip has been released by this same raised portion 15 striking the raised cam 20 on the top surface of the first handle 1. The spring 14 may have a light torsional force since there is little resistance to the return opening of the handle 9, so that when that handle strikes the cam 20 the opening or return movement will stop, unless further pressure is applied to it. If further pressure is applied, the leverage between the cam 20 and the shaft will unlock the nip and permit the spring to complete its opening or return action on the handle 9. The spring may also be designed to give an outward thrust to the handle plate 11 through its other fixing point 21: which may bc on the body of the first handle and plate 1 and 2, so that the second handle 9 and 11 returns to the correct position to engage the high point 15 with the cam 5 on the first handle plate 2, ready for the next can and without extra and undesirable opening, thereby permitting the can opener to be used with comfort by persons with small or weakened hands.

FIG. 6A is a view of the assembled can opener ready to receive a can to be opened as seen from the side from which the can is presented and where the cutter wheel can be seen. The drive wheel teeth are shown withdrawn to permit easy access for the can rim into the space below the cutter wheel or knife device.

FIG. 6B shows the same situation but is seen from the rear of the can opener. It will be observed that the spring 14 has moved the second handle plate 11 to a fully withdrawn position so that the drive wheel teeth are not obstructing the entrance of a new can and that the high point 15 of the second handle 10 is automatically engaged with the cam 5 on the first handle plate 2. The arrangement is thus ready for a first squeeze of the handles 1 and 9, which will utilize the leverage between the cam 5 and the tip of the handle at 15 against the shaft or rivet 12 to cause the penetration of the can top by the cutter. as a result of the upward pressure of the drive wheel. (Note that the cutter devices does not slide or change position other than to rotate).

FIG. 7A is a view of the assembled can opener, as it would be with a can being opened, That is to say that the drive wheel teeth are engaged with the rim of the can on its underside and have forced the cutter to penetrate the can lid while the continued squeeze of the handles causes the can to rotate while the cutter cuts the top lid off. it should be observed that the shaft or rivet is moved along the slot 8 in part by this rotation and friction caused by the drive wheel and is held in that position during the return spring movement prior to the next squeeze.

FIG. 7B shows the same situation as that shown in FIG. 7A but seen from the reverse side. It will be seen that the high point 15 of the second handle 10 is now clear of the cam 5 on the first handle plate 2, The second handle 9 is thus free to be repeatedly squeezed, then released to be returned to the cutting position by the spring 14, without touching the cam 5 again, until the can is opened and released as in FIG. 6. The ratchet device is beneath the second handle and cannot thus be seen in this drawing. There may also be a spring-loaded button or other device fitted between. the two handles to retain the two handles in a roughly parallel attitude for storage or display.

FIG. 7C shows the assembled can opener at the end of the return spring stroke or at an opening stroke between the two handles. At this point the high point 15 of the second handle 10strikes the cam 20 on the body 2 of the first handle and prevents further opening, for ease of operation by hand. However, if the handle 9 is pushed further open, the leverage between this cam 20 and the high point 15 and the shaft 12 will force the shaft 12 to move back down the slot 8 and will thus release the body of the can and return the arrangement to the position described in FIG. 6B.

1. A can opener, comprising first and second handle members, knife means, drive wheel, ratch device and the spring, wherein:
The said first handle members and the second handle members are pivotably connected about an axis, and a radially facing slot is formed on the first handle members, and also a apporiate protrution in shape is also formed on the said first handle members;
The cutting wheel being rigidly mounted onto the first handle member,
The drive wheel partly protruding through said slot, and engages with the said first handle members and and the second handle members through the axis;
The ratch device and the spring are disposed above the second handle members as well as under the drive wheel, in which one end of the spring is mounted on the first handle members, and the other end is mounted on the second handle members.

2. The can opener according to the claim 1, wherein the first handle member is shaped as a doubly bent plate, and said slot is disposed on the said plate, in the meantime the said protrusion is also on the upper end of the said plate.

3. The can opener according to the claim 2, wherein the axis which engaging the said first handle members, the second handle members and the drive wheel is the rivet, the drive wheel can rotatebly connected to the said handle members by the rivet, and the drive wheel is slidely arranged in the slot on the said first handle members by the rivet.

4. The can opener according to the claim 3, wherein the said rivet has a head part having bigger diameter, the head part having the bigger diameter is in the same side with the cutting device within said handle members plate.

5. The can opener according to the claim 1, wherein bearing material is disposed on the second handle members, and the bearing material is in the position of above the said handle and near the drive wheel.

6. The can opener according to the claim 1, wherein the said spring is the coil spring.

7. The can opener according to the claim 1, wherein the plate of said first handle members has a sloped part, and the said slots are made in the the middle of the sloped part.

8. The can opener according to the claim 1, wherein the magnet is disposed near the cutting device.

9. The can opener according to the claim 1, wherein the cutting device is the cutting wheel or the knife device.

10. The can opener according to the claim 1, wherein the said first handle members disposes the protrusion and the similar things on the side which being away from the cutting device.
